(19) United States
(12) Patent Application Publication
(10) Pub. No.: US 2015/0046189 A1
(43) Pub. Date: Feb. 12, 2015

(54) ELECTRONIC HEALTH RECORDS SYSTEM

(71) Applicant: Michael Dao, Garden Grove, CA (US)

(72) Inventor: Michael Dao, Garden Grove, CA (US)

(21) Appl. No.: 14/455,477

(22) Filed: Aug. 8, 2014

Related U.S. Application Data
(60) Provisional application No. 61/864,308, filed on Aug. 9, 2013.

(51) Int. Cl. G06Q 50/24; G06Q 10/10

(52) U.S. Cl. CPC G06Q 50/24; G06Q 10/10
USPC 705/3

(57) ABSTRACT

A method and system for producing and storing information related to medical health of at least one patient comprising:
1) capturing data gleaned by audio and video recording of an interview with the patient conducted by a health-care professional,
2) electronically digitizing the data, and
3) storing the digitized data in an electronic format in a computer having an operating system capable of accessing, editing, analyzing, and searching the stored digitized data.

### CROSS-REFERENCE TO RELATED APPLICATIONS

This application claims priority to U.S. Provisional Application No. 61/864,308, filed Aug. 9, 2013, in the U.S. Patent and Trademark Office. All disclosures of the documents named above are incorporated herein by reference.

### BACKGROUND OF THE INVENTION

1. Field of the Invention

The present invention relates generally to an improved system for electronic capture of health records information.

2. Description of the Related Art

In the traditional setting, when a patient goes to see a physician, nurse or other health professional, the health professional typically records information about the health of the patient in a very conventional approach using, e.g., a pen and notepad, or otherwise by taking shorthand notes or transcribing information into a book or other standard template. However, such conventional approaches for recording information about the health of a patient suffer from a number of disadvantages. For instance, with such conventional approaches, the health professional will frequently not capture all the information communicated by the patient. Thus, critical information about the health of the patient is often overlooked, missed, omitted or incompletely recorded by the health professional. Such omissions or incomplete recording not only lead to potential misdiagnosis; inaccurate records; and lead to an inaccurate profile of the patient's comprehensive health, but such practices may also result in medical malpractice and other causes of action resulting in legal liability.

It is thus an object of the present invention to provide an improved health records system which overcomes the above-noted disadvantages.

### SUMMARY OF THE INVENTION

According to one preferred embodiment, the present invention relates generally to a fully integrated, interactive system for electronic capture of health records information. More particularly, one embodiment of the invention relates to a method of producing and storing information related to medical health of at least one patient comprising:

1) capturing data gleaned by audio and video recording of an interview with the at least one patient conducted by a health-care professional,

2) electronically digitizing the data, and

3) storing the digitized data in an electronic format in a computer having an operating system capable of accessing, editing, analyzing, and searching the stored digitized data.

Another embodiment of the invention comprises a system for producing and storing information related to medical health of at least one patient comprising:

1) audio and video recording elements capable of capturing data gleaned by audio and video recording of an interview with the at least one patient conducted by a health-care professional,

2) means for electronically digitizing the data, and

3) means for storing the digitized data in an electronic format in a computer having an operating system capable of accessing, editing, analyzing, and searching the stored digitized data.

According to another preferred embodiment, the present invention relates to a fully integrated, interactive system for electronic capture of health records information that is fully operational as a web based or Internet-based system.

Additional preferred embodiments, aspects and/or advantages of the invention will be set forth in part in the description which follows and, in part, may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1 and 2 depict examples of interactive interfaces wherein both audio and video information is captured during a meeting or session between a patient and a health professional.

Still other objects and advantages of preferred embodiments of the present invention will become readily apparent to those skilled in this art from the following detailed description, wherein there is described certain preferred embodiments of the invention, and examples for illustrative purposes.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The present invention relates generally to an improved system for electronic capture of health records information. It is to be understood that all references cited herein are incorporated by reference in their entirety.

Reference will now be made in detail to certain embodiments of the present invention, examples of which are illustrated in the accompanying drawings, wherein like reference numerals refer to the like elements throughout. It is to be understood that the invention is capable of modifications in various respects, all without departing from the spirit and scope of the invention. Accordingly, the description should be regarded as illustrative in nature, and not as restrictive.

The term “electronic health records” (or herein abbreviated as “EHR”) as used herein is intended to encompass, but is not limited to, any information about the past, present and/or future (predicted) health of an individual, including for instance any and all events and incidents that pertain to the individual's past health history/medical history; any allergies and/or other known adverse reactions to medications; any family-related medical history and medical events (e.g., incidence of cancer; cardiovascular disease; ete); and any other type of data and information related to an individual's past, present and/or future (predicted) health that might be gathered by a physician or other healthcare professional.

Of course, before any EHR are obtained by a health professional, it is of paramount importance that the patient first grant their clear, explicit and full written consent for the use of the system of the present invention (including capture and storage of their EHR by audio and video means), again before the EHR system is ever used.

One representative example of a patient's electronic health records (EHR) is a health record of an individual that is generated electronically from the digital recordings that are obtained from a real-time, audio-taped and video-recorded session between a health professional and the patient, wherein it is to be understood that the digital recordings obtained from an audio-taped and video-recorded session are transmitted to a secure computer system (as described elsewhere herein) for search, storage, analysis and retrieval of the patient's confidential electronic health records.

The private and confidential, audiotaped and video-recorded session between the health professional and the patient can take place, for example, in real time at any suitable place, time and geographic location anywhere internationally, for example:
In-person, private, confidential audiotaped and video-recorded session between a health professional and the patient at a solo medical practice;
In-person, private, confidential audiotaped and video-recorded session between a health professional and the patient at a health clinic;
In-person, private, confidential audiotaped and video-recorded session between a health professional and the patient at a hospital;
In-person, private, confidential audiotaped and video-recorded session between a health professional and the patient at the patient's home, e.g. when the health professional sees the patient at home because the patient is unable to leave their house, for instance, in the case in which the patient is too old to leave their home because of illness, or because the patient suffers from a mental or physical incapacity that prevents them (or makes it very difficult) to leave their home, and thus a “house-call” or in-person visit by a healthcare professional to their home is preferred;
In-person, private, confidential audiotaped and video-recorded session between a health professional and the patient in a “mobile health unit” such as a specially equipped mobile vehicle, in which the health professional provides on-site, private, confidential visit and consultation to the patient at any remote site.

In all of these situations, the private and confidential, audiotaped and video-recorded session between the health professional and patient is used in order to electrically capture all of the audio and video content of the session, thus capturing all of the patient's EI-1R preferably in “real-time” (i.e., at the same time that the session between the health professional and the patient is happening). Examples of the audio and video content that is captured during the session between the health professional and patient include, for example, all questions answered by the health professional (for instance, but not limited to, any questions about the health history of the patient and any signs, symptoms, etc. that the patient might be suffering from, as well as any questions about past or current medications that the patient is taking). The audio and video content that is captured during the session between the health professional and patient (which will be used to generate the patient's EHR) can also include, for example, all verbal responses provided by the patient; all body movements or gestures by the patient; all images of the patient's anatomy or other physical images of the patient that are captured by video-recording during the session.

The audio and video content that is captured during the private, confidential session between the health professional and patient, e.g. with one or more video cameras and microphones (which is used to generate the patient's EHR) can also include, for example, the entire dialogue/conversation between the health professional and patient, including for instance, all questions and answers about signs, symptoms, and the patients health; any physical examination of the patient by the health professional; and any statements made by the health professional about a prescription for the patient, as well as all other statements made by the health professional and patient during the session. In effect, all of the audio and video content that is captured during the private, confidential session between the health professional and patient (which will be used to generate the patient's ERR) reflects and mirrors all of the entire content of the actual, live session between the health professional and patient.

Thus, the present invention again provides the surprising advantages and long-felt but unmet need for reducing medical and legal liability that is traditionally associated with gathering incomplete information from a traditional meeting between a health professional and patient, i.e., in which, in the traditional meeting, information that is communicated by the patient to the health professional is lost or incomplete because traditionally the session is not video-recorded and is not audio-taped.

The present invention also significantly improves the overall quality of patient care since the health professional (in accordance with the present invention) can focus on the conversation with the patient and focus on diagnosing the patient while maintaining their full attention on the patient, without being constantly distracted and interrupted by the constant need (in the traditional doctor-patient setting) to always have to look down at a notepad or binder while the doctor or health professional tries to listen to the patient at the same time as trying to take notes about what the patient is saying, which traditionally has been very inefficient and inevitably leads to information being lost (thus leading to legal and medical liability). Also, in the traditional doctor-patient setting, in which the content of the session is not recorded by video-recording and audio-tape, there has been no way for the health professional to literally “go back” and listen again and again, if necessary, to exactly what the patient said during the session. Instead, with the present invention, the doctor or other health professional “go back” and literally ‘replay” the entire audio-taped and video-recorded private, confidential session between the health professional and patient (which is used to generate the patient's EHR) to literally see, hear and watch again exactly what was done, said by the patient, and thus literally see and hear again all of the content from the live session with the patient.

The EHR of the patient can be archived and updated as needed based on updated health status visits with the patient, i.e. at a follow-on session or follow-up “check-up’ with the doctor or other health professional with the patient, in which these follow-up sessions are also audio-taped and video-recorded as private, confidential sessions between the health professional and patient. The privacy and confidentiality of the patient's EHR is always maintained, i.e. in a manner that is fully compliant with HIPPA regulations and requirements and all other applicable laws and regulations.

Before the systems of the present invention are used for capturing and storing the patient's EHR information, the patient is provided with a comprehensive disclaimer to the patient, such that the patient will know in advance that the privacy and confidentiality of the patient's EHR will be maintained in a manner that is fully compliant with HIPPA regulations and requirements and with all other applicable laws and regulations.

In accordance with the present invention, a preferred process for capturing and storing the patient's health information is to capture the health information by audio and video recording, and thereafter the patient's ERR is recorded, captured, digitized and stored by electronic means (e.g., by a secure computer and information processing system). The system according to the present invention improves the efficiency and quality of overall healthcare for both the healthcare provider and the patient.

In accordance with the present invention, a patient's EHR can include any type of information related to the patient's health, including for example, but not limited to:
the patient's contact information.
information about prior and current visits to health care professionals.
any history of allergies.
health insurance information.
family medical history.
immunization status.
information about any known and/or diagnosed medical conditions or diseases.
a list of all past and present medications that the patient is taking;
records of hospitalization.
information about any surgeries or procedures performed.

In accordance with the present invention, there are numerous surprising and unexpected benefits in addition to the other benefits that are described herein. Additional representative examples of benefits of the present invention include, for instance:

the ability to automatically share and update information among different healthcare facilities, offices and organizations, with the consent of the patient, and as long as sharing the information entirely protects the privacy and confidentiality of the patients EHR and health information;
more efficient storage and retrieval of the patient's health records.
more accurate and complete health records of the patient;
greater efficiency for both the patient and healthcare professionals;
significant improvement of overall quality of care since the healthcare professional can focus on the conversation with the patient and focus on diagnosing the patient while maintaining their full attention on the patient, without being constantly distracted and interrupted by the constant need (in the traditional doctor-patient setting) to always have to look down at a notepad or binder while the doctor or health professional tries to listen to the patient at the same time as trying to take notes about what the patient is saying, which traditionally has been very inefficient and inevitably leads to information being lost (thus leading to legal and medical liability).
The ability to share multimedia information, such as medical imaging results, among locations (for instance, using telemedicine technologies);
The ability to link EI-ER to sources of relevant and current research.
Easier standardization of services and patient care.
Provision of decision support systems (DSS) for healthcare professionals.
Less redundancy of effort.
Lower cost to the medical system once implementation is complete.

Preferably, the system of the present invention stores all of an individual patient's electronic health records (ERR) in electronic format, i.e. as an “electronic record” which (as described elsewhere herein) is maintained by the provider, and which can be updated as needed over time (based on follow-up visits with the patient) and may include, for instance, information that is captured by audio and video means during the live session with the patient including the patient's medical history, current medications, demographics, doctor's notes and other important administrative information.

As further described elsewhere herein, the video ERR system of the present invention will include the secure and reliable implementation of measures, policies and safeguards to ensure that security is always maintained governing data exchange, and that the patient's privacy and security of their ERR and patient data, and the confidentiality of their health information data, is securely and reliably maintained.

In a preferred embodiment, the improved system for electronic capture of health records information comprises a “fully integrated” system wherein the electronic health records system comprises, but is not limited to:

1) at least one component for capturing by video the information communicated between a patient and a health professional;

2) at least one component for capturing by audio the information communicated between a patient and a health professional;

3) at least one component for recording and storing the video-captured information communicated between a patient and a health professional; and

4) at least one component for recording and storing the audio-captured information communicated between a patient and a health professional.

The “at least one component for capturing by video” can include any system, device, component or tool that is operable for capturing information by video. For instance, according to one preferred embodiment, a video camera or other video recording equipment can be used to capture the information communicated between a patient and a health professional. Multiple video-cameras can also be used, such that there are multiple video angles for recording all the communications between the patient and the health professional.

The “at least one component for capturing by audio” can include any system, device, component or tool that is operable for capturing information by audio. For instance, according to one preferred embodiment, any suitable type of microphone can be used to capture the audio or vocal information communicated between a patient and a health professional. For instance, a button microphone, capacitor microphone, carbon microphone, condenser microphone, contact microphone, dictaphone, digital microphone, dynamic microphone, electrostatic microphone, hydrophone, laser microphone, lavalier microphone, mic, mike, moving coil microphone, omnidirectional microphone, parabolic microphone, piezoelectric microphone, tap, or wireless microphone or any other suitable type of microphone can be used in accordance with the present invention.

The “at least one component for recording and storing the video-captured information communicated between a patient and a health professional” can include, for example, a memory element and a computer system that is operable in conjunction with said memory element for recording video input. Examples of a memory element for recording video input include, for instance, a magnetic disk, cache memory device, or tape drive memory device.

The “at least one component for recording and storing the audio-captured information communicated between a patient and a health professional” can include, for example, a memory element and a computer system that is operable in conjunction with said memory element for recording audio input. Examples of a memory element for recording audio input include, for instance, a magnetic disk, cache memory device, or tape drive memory device.

According to one embodiment, the audio component of a patient's EHR the present invention is an optional feature. The volume and other parameters of the audio input, e.g., when the conversation between physician and patient is being recorded, can be adjusted as needed.

According to one preferred embodiment, an internal/controlled webcam can also be used for the capture of health records obtained from a conversation between physician and patient, Thus, the webcam, which essentially operates as a video camera, can be used to transmit both video images, i.e. images of a confidential session held between a physician and a patient, and the audio from the physician-patient session, in real time to a private and confidential computer or computer network, often via USB, internet, or Wi-Fi. Of course, as described further herein, even with use of an internal/controlled webcam, the privacy and confidentiality of the patient's health records information is always maintained.

According to yet another preferred embodiment, all of the EHR including the audio and/or video input received using the electronic health records system of the present invention can be stored in such a manner that the data and information received, e.g., data and information about the patient's health history and records, can be stored in a digital format; and/or transcribed to a written format or any other suitable storage format.

### Operational any Type of Computer Systems Including any Type of Computer Operating System

It is to be understood that some or all of a patient's EHR can be stored, archived, catalogued, accessed, retrieved, analyzed, processed and otherwise used for any suitable purpose by healthcare professionals via the use of any type of computer system which can run on any type of computer operating system (OS). Examples of computer systems include any type of personal computer system, and/or web-based computer system as well as secure, cloud-computing system. Examples of computer OS that can be used for operating the computer system include, but are not limited to,

the Android OS;

the OS running Apple® iPhone/iPad/and other Apple-brand devices;

Windows® OS;

Palm® OS;

Blackberry® OS;

one or more servers can also be used to access, store arid otherwise retrieve a patients ERR information.

In addition, the present invention contemplates that any suitable type of software language, program or programs, Internet-based programs, web-based programs, and/or other programming tools can be used to write and execute the underlying software code for implementing the systems of the present invention for receiving or retrieving the audio and video ERR content from a session between the patient and the healthcare provider, as well as enabling a user of the system to securely and reliably carry out processes and instructions for storing, archiving, cataloguing, accessing, searching, analyzing, processing and otherwise using a patient's EHR that is recorded by audio and video means during a session between the patient and the healthcare provider. The systems of the present invention can also be implemented using any suitable type of computer hardware systems and configurations, or via network-computing, cloud-computing, or any number of database(s) or information system(s), as long as the privacy and confidentiality of the patient's ERR is maintained.

Moreover, the particular means utilized to record and permanently store the information communicated between a patient and a health professional may comprise, for example, any of the commonly used, commercially available memory means operable with a computer system for reading and execution of information, such as, for example, magnetic disks, tapes, cassettes etc.

In accordance with one preferred embodiment, the fully integrated system for electronic capture of a patient's health records information of the present invention is fully operational as a web-based or Internet-based system.

According to one preferred embodiment, well-established cloud service providers can be used to share patient EHR (again, after receiving patient consent, and after a disclaimer has been given to the patient in advance) to help health care businesses reduce operational costs and improve overall provision of patient diagnosis, treatment and care. Cloud service providers can offer cloud-based services for the health care industry to help monitor, analyze arid react to real-time patient information.

Moreover, digitized patient data that is collected according to the present invention, i.e. in which a patient's ERR is captured with audio and video input, and is then digitized, can help reduce unnecessary and wasteful duplicate tests, administrative inefficiency and redundant paperwork, which equate to some several billion dollars in annual spending. According to recent reports, primarily because of regulations, the health care sector is at least ten years behind the financial services industry when it comes to utilizing information technology. To reduce costs and improve care, patient information should be exchanged digitally in accordance with the present invention.

In accordance with another preferred embodiment, the collection, storage and retrieval of a patients health records information can be accomplished, for example, using a secure, online portal or a secure, encrypted intranet. It is to be understood that these are provided only for illustrative purposes and are not intended to limit in any way the scope of the present invention.

A patient's health records information can be stored in all-digital format. This obviates the need for keeping paper records and avoids the problems associated with keeping old paper records which are susceptible to decay or being lost.

In accordance with a preferred embodiment of the present invention, the patient's EHR will always be stored, archived, retrieved, processed and otherwise used in a manner that protects the patient's privacy and protects the confidentiality of the patient's EHR. It is preferred that authentication, validation and/or secure encryption of the patient's ERR can be used to ensure that there is no fraudulent or counterfeit attacks on the patient's ERR. Any suitable measure can be taken to ensure that there is no fraud, misuse, corruption, tampering, hacking, counterfeiting or other inappropriate access or use of a portion of the patient's EHR.

Operational with Any Suitable Electronic Application or “App”

It is also to be understood that, in one preferred embodiment, some or all of a patient's ERR can be stored, archived, catalogued, accessed, retrieved, analyzed, processed and otherwise used for any suitable purpose by healthcare professionals via the use of any type of electronic, i.e. computer or mobile-device computer application (or “app” as it is commonly referred). Any suitable “app” can thus be developed and used in accordance with the present invention for the purposes of, for example, securely and reliably storing, archiving, cataloguing, accessing, retrieving, analyzing, processing and otherwise using and transmitting a patient's EHR. Use of such “apps” can greatly and significantly help improve access to the patient's ERR for healthcare providers in a secure and confidential “data warehouse” for example; and cal also be used for accessing a large database of patients' ERR.

It is another embodiment of the invention to provide a secure and confidential “data warehouse” or electronic database of many patients' electronic health records, so that such a database can be used by healthcare professionals for research, diagnosis, analysis, or for other healthcare purposes. A patient would grant their written consent for allowing their individual EHR to be used in such a “data warehouse” or database.

Any type of electronic device, mobile device, electronic “tablet”, computer or other form of a digital or other electronic device can be used to run any mobile “application” or “app” in accordance with the present invention for the purposes of, for example, securely and reliably storing, archiving, cataloguing, accessing, retrieving, analyzing, processing and otherwise using and transmitting a patient's EHR. Examples of such electronic devices, mobile devices, computerized or other form of digital devices include, for example, Android; Apple®; iPhone/iPad and other Apple-brand devices; Palm® OS devices; and Blackberry® devices. It is to be understood that any other type of mobile device, computerized or other form of a digital or other electronic device can be used in accordance with the present invention for running such “applications” for securely and reliably storing, archiving, cataloguing, accessing, retrieving, analyzing, processing and otherwise using and transmitting a patient's EHR. The present invention is compatible with mobile health applications for smart phones, for instance, compatible with health applications for Apple® devices. Health care providers can thus leverage many applications to help patients better manage chronic disease, weight loss and other conditions, and medication reminders and heart rate monitors.

### Telemedicine Applications

According to another preferred embodiment, the electronic health records (EHR) system of the present invention is completely operational, and thus can be completely integrated, with one or more telemedicine programs and/or services, whereby the telemedicine services involve the use of telecommunication and information technologies in order to provide clinical health care at a distance.

Example of telecommunication and information technologies that can be used to provide transmission of a patient's EHR (in which the EHR is recorded with audio and video, in accordance with the present invention), e.g. for telemedicine applications, include, for example, Skype Apple® FaceTime or other current or future technologies or platforms with audio and videoconferencing capabilities.

Thus, for example, when there is an audio and video record of a patient's EHR, which again is stored in a secure manner that ensures the protection of the patient's privacy and confidentiality of their EI-JR. then Skype Apple® FaceTime or other current or future technologies or platforms with audio and videoconferencing capabilities can be used to communicate the ERR information to other health professionals. Thus, once a patient's ERR is obtained, telemedicine can effectively be used, i.e., by the use of telecommunication and information technologies, in order to provide clinical health care for the patient even over long geographic distances. Thus, with the use of telemedicine, and based on the patient's ERR, a healthcare provider can provide clinical health care for the patient even though the patient may be located at a distance from the provider.

Once a patient's ERR is obtained, a written transcript can also be produced that contains all or a portion of the ERR information. Since the patient's EI-JR can always be updated at any time with new or changed information, i.e., after a subsequent visit by the patient to see a healthcare provider (such as the patient's primary doctor), a current written transcript can always be obtained for the healthcare provider, the patient, or both.

In addition, the EI-IR can always be searched to retrieve particular information. Individual data, keywords, numbers, and other specific information that is captured by audio and video-recording during a healthcare provider-doctor session (and that is stored within the patient's ERR) can also be tagged or otherwise marked or labeled, for instance digitally or electronically marked or labeled, to improve the capability of electronically searching for particular information within the EHR. Mobile “apps’ can be used to search, retrieve, communicate and/or analyze information within the patient's EHR.

According to another embodiment, information that is contained within the ERR can also be date and time-stamped to improve the capability of searching for specific types of information within the ERR. Voice recognition technology can also be used to search for information within the EHR. For instance, the system of the present invention can be programmed such the system will use voice recognition to specifically search and identif’ a doctor's voice, e.g. when the doctor issues a prescription to the patient during a session with the patient and recorded by audio and video.

The present invention thus surprisingly enhances the overall quality of patient care and simultaneously reduces costs. The present invention also surprisingly addresses a major problem in the provision of health care worldwide, namely, by significantly improving the quality of care without increasing costs. As described herein, a healthcare provider can focus on the patient during a audio-taped and video-recorded session with the patient, instead of missing critical information that typically happens with traditional meetings with patients (since traditional meetings are not recorded and audio and video content is not traditionally captured). With the present invention, which provides for the exchange of a patient's ERR health information securely and confidentially and also provides for use of the EUR in telemedicine applications (for example, a doctor can communicate remotely with a patient and/or with another healthcare professional), there is an opportunity to leverage the benefits of telemedicine to improve the provision of care and enhance the patient experience and outcome.

More generally, the surprising benefits and capabilities of the ERR system of the present invention can be used in conjunction with not only telemedicine applications, but also with wireless networks, virtual care solutions, information exchanges and cloud computing, all of which can be used to further empower health care providers to improve their business operations while giving them more time to provide quality care, and all while securely maintaining the privacy and confidentiality of the patient's EHR.

When used in conjunction with the present invention, telemedicine effectively removes the geographic barriers to quality care. In conjunction with the present invention, in which ERR are stored securely and confidentially, and through the use of telemedicine, hospitals can reduce preventable hospitalizations. Additional benefits of the present invention, used in conjunction with telemedicine, include bringing the promise of providing remote care for the aging population, and better serving patients with chronic conditions and difficulties in traveling. The technology of the present invention can enable sessions between a patient and a healthcare provider to be audio-taped and video-recorded, stored and retrieved for patients in previously un-served or under-served markets and geographic locations around the world, helping improve care for those markets, and bring in new revenue for providers.

Chronic disease accounts for 75 percent of every dollar spent on health care. At current growth rates, chronic disease spending, which is currently at $1.3 trillion, will more than double, to $2.2 trillion, by 2020. By leveraging the present invention, providers can help patients better manage their conditions from anywhere at any time. For example, approximately 95 percent of diabetes care is done by the patient at home, work or on the go—not by a clinic. Empowering the patient can be replicated in other areas of chronic care by harnessing the present invention, in conjunction with telemedicine and mobile health applications, to help provide patients with remote support and disease management.

In accordance with the present invention, in which a patient's EHR records (captured with audio and video) can be communicated to other healthcare providers, regardless of their geographic location, and while patient privacy and confidentiality is maintained, the use of computer applications, such as smart applications (or “smart apps” such as mobile phone applications) can help both patients and the healthcare provider better and more efficiently manage the patient's health and well-being in real time, and anywhere geographically (via telemedicine), thus providing alerts to patients to take medications, exercise or follow a recommended diet, for example.

With the telemedicine applications of the present invention, the present invention also enables tale-health networks to expand their value to members and the community by connecting rural and remote providers across existing infrastructures. In this manner, the EHR of a patient that is captured in a rural setting, for example, can still be collected and analyzed, and then transmitted to other healthcare providers, even though the other healthcare providers maybe located at a distance. It also presents new partnership opportunities that will enable telehealth networks to expand those infrastructures and improve the overall quality of care for patients.

Improvements in health information technology (I.T.) will also enable components for remote care and provide complementary tools and systems for achieving the goals of the present invention, by providing further relevant technology tools for collecting (via audio and video), storing, retrieving and analyzing the EHR of a patient. Improvements in health LT. will also enable improved digital data/information sharing of the patient's ERR. Also, the widespread adoption of health I.T. will assist in harnessing and understanding collections of data, for example, when multiple patients' EHR are collected together and analyzed for trends or instances of disease, to improve the overall quality of patient care. This will help doctors further improve health care by aggregating and analyzing large amounts of patient data on treatments, conditions and more, based on the ERR systems of the present invention.

In one embodiment, utilizing a common platform can also unite the patient and healthcare provider for better information sharing of EHR Creating a common data pool for patients' EHR (for instance, from multiple ERR records collected according to the present invention) will transform the health care sector into a technology leader in storing, accessing and sharing critical patient information. This will ultimately help reduce redundant testing and paperwork, and reduce the chance of medical errors. The present invention will also enable more converged paths from the fields of healthcare and information technology, more efficient use of resources and the integration of health information and telehealth technologies.

### Retrieval of Health Records

In accordance with one preferred embodiment, and as described herein, the health records information that is communicated between a patient and a health professional can be video-recorded, audio-taped, stored and retrieved as EHR using any number of different electronic devices.

A patient's electronic health records information can also be stored and retrieved using any suitable type of secure, reliable, portable storage media such as a memory card, flash memory devices, USB sticks, etc. Such secure, reliable, portable storage media can be used, for example, by a physician or other health professional for accessing the EHR information anytime the information is needed. Advantages include, for example, reliable, easy, portable access to the patient's health records information.

In accordance with another preferred embodiment, the health records information that is communicated between a patient and a health professional can also be transmitted, stored and retrieved securely and confidentially using any number of different wireless electronic devices. For example, the health records information can be securely and confidentially transmitted, stored and retrieved via a wireless connection to a digital device and then the information can be securely and confidentially analyzed or otherwise used as necessary. The health records information can also be accessed via secure cloud computing or other electronic portal.

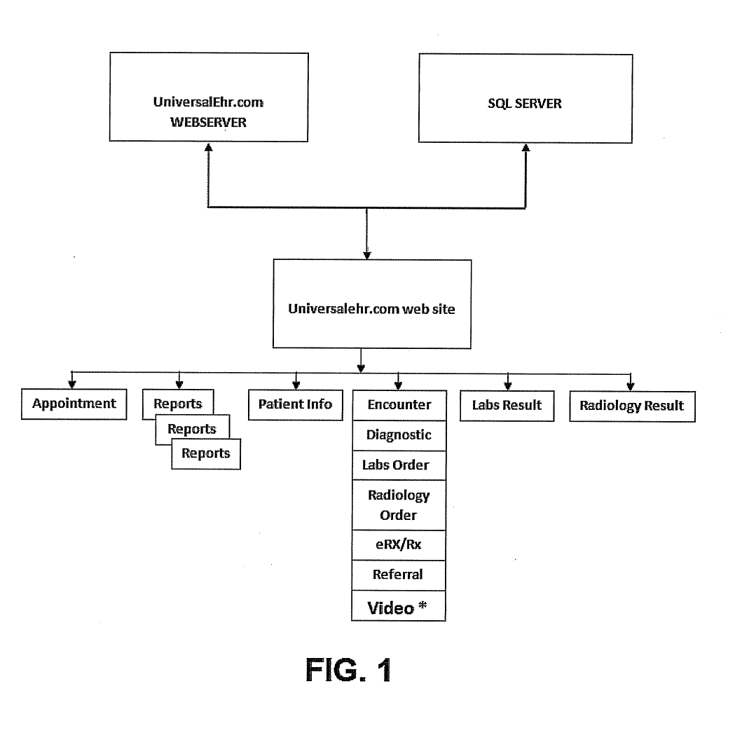

In accordance with the electronic health records system of the present invention, the electronic health records can be visualized with any suitable monitor or screen. As depicted in the example in FIG. 1, the electronic health records of a particular individual can be accessed using any number of drop-down menus available by using a computer system and visual display monitor or screen, for example.

In another preferred embodiment, a drop-down menu, for instance, which can appear on a screen as depicted in FIG. 1, can be provided on a computer monitor that enables the physician or other healthcare professional/provider to visualize the EHR. The drop-down menu can be designed to display the content of the EHR in any number of categories, for instance, by subject matter, or based on what was said by the patient; or based on the patient's medical history; or based on any other criteria that is desired. Based on the EHR, a physician or other healthcare professional provider can efficiently and reliably and accurately review (and re-review as needed or desired) the content of the recorded session, review the recording as needed, select an appropriate prescription for the patient, based on the electronic health records compiled for a certain patient, or make other healthcare decisions and recommendations based on the content of the EHR recorded during the session with the patient. The drop-down menu can, for example, contain a comprehensive list of prescription pharmaceutical products that can be selected by the physician. The drop-down menu can contain any other information based on the EHR content and captured by audio and video means.

Any number of suitable computer software and programming tools/systems can be used to integrate and link the audio and video inputs with the rest of the system that functions to store, analyze, archive, process and retrieve the electronic health records.

Thus, as described herein, any number of suitable computer software and programming tools/systems can be used to implement the appropriate steps for storing, analyzing, archiving, processing and retrieving the electronic health records. Examples of such computer software and programming tools/systems include, for instance, Java based or Linux-based programming systems. Also, the electronic health records system of the present invention can be implemented on any computer hardware platform. The electronic health records system of the present invention can also be operated by a controller or other operator, and can be set up such that only authorized individuals are granted access to operate the system and access patient health records.

### Privacy and Confidentiality of the Patient's Health Records Information

As described elsewhere herein, in accordance with the electronic health records system of the present invention, the privacy and confidentiality of the patient's health records information is always maintained. To comply with appropriate laws and regulations governing patient privacy and confidentiality in the healthcare setting, patient consent is required before recording their private session with a healthcare provider; and the patient would always be advised in advance of the electronic health records system being utilized. All of the capture, storage, and any use of the patient's health records information will be fully compliant with all laws governing patient health records, including the Health Insurance Portability and Accountability Act of 1996 (“HIPAA”). The Health Insurance Portability and Accountability Act of 1996 (“HTPAA”) and its regulations (including the privacy rules) protect the privacy of an individual's health information and govern the way certain health care providers and benefits plans collect, maintain, use and disclose protected health information (“PHI”).

### Voice Recognition

According to another preferred embodiment, the electronic health records system of the present invention can also optionally use voice recognition. In other words, a patient's electronic health records can be searched, accessed, analyzed, processed and/or retrieved, in addition to any other functions which can be performed utilizing the electronic health records, based on the use of voice recognition technology to search for the unique voice (e.g., vocal characteristics) of the individual patient and the healthcare professional. Thus, according to one example, specific information within the electronic health records can be retrieved based on the unique vocal characteristics of the individual patient arid, optionally, the physician or other healthcare professional.

### Additional Advantages

The electronic health records system of the present invention provides a number of significant advantages over conventional approaches to obtaining health records of a patient. For example, the entire session, including all video and audio, from a meeting between a physician and patient is recorded. There is no loss of information, and no collection of incomplete and/or inaccurate information, which are huge problems associated with conventional approaches for documenting health records of a patient merely by pen and paper when a healthcare professional meets with the patient. In the traditional setting, the healthcare professional typically transcribes their own notes (if any notes) of the meeting by pen and paper, or by trying to write on a tablet while trying to simultaneously listen to the patient, which is plagued with problems of inefficiency, poor communication with the patient, and loss of information and data collected because traditionally there is no video and audio recording of the session with the patient. Loss of information typically leads to problems for the healthcare provider in terms of poor diagnosis, misdiagnosis, etc., and thus medical and legal liability.

In addition, the electronic health records system of the present invention significantly improves the overall quality of communications between the patient and healthcare professional, e.g. doctor or nurse, since it relieves the physician/healthcare professional from trying to take notes on the patient's health history, etc., during the actual meeting with the patient. Instead, the present invention provides for an electronic system that captures all of the audio and video input in real-time and thus ensures that none of the information communicated between patient and physician is lost, overlooked, missed, or incompletely recorded. Thus, as described elsewhere herein, the electronic health records system of the present invention also significantly reduces potential medical and legal liability for the physician/healthcare professional.

Since the electronic health records system of the present invention ensures that all of the audio and video information communicated between patient and physician is captured in real-time, the system of the present invention also significantly improves the overall quality of the patient's healthcare and also increases the level of safety associated with the healthcare administered to the patient, since the system of the present invention significantly reduces the chance for misdiagnosis, mistreatment and other potential human errors associated with conventional approaches that traditionally do not make it possible to gather all of the real-time, comprehensive information about the health status of the individual. Also, as described elsewhere herein, the electronic health records system of the present invention also ensures that the privacy and confidentiality of the patient's health records is securely maintained.

Moreover, the system of the present invention also address concerns that face healthcare facilities looking to reduce costs while maximizing operational efficiencies. Costs are reduced, for example, because—with the present invention—there is significantly less need for internal, inefficient, wasteful, time-consuming and expensive administrative record-keeping measures, e.g., for maintaining large volumes of handwritten paper records of patients' health records, since the electronic health records system of the present invention ensures that all of the audio and video information communicated between patient and the healthcare professional is captured in real-time and safely archived electronically for later review, analysis, retrieval, etc.

The present invention is further illustrated by the following examples. These examples are provided by way of illustration and are not intended in any way to limit the scope of the invention. The examples should therefore not be construed as limitations on the scope of the invention, but rather should be viewed as an exemplification of preferred embodiments thereof. Many other variations are possible.

### Example 1

FIG. 1 depicts an exemplary system for improving the feature of health records information. When a patient arrives to meet with a physician, the patient is seen in a private room so that the conversation between the physician and patient remains private and confidential. The patient is first given a disclaimer and consent form for allowing the session to be recorded by video and audio means in response to questions by the physician, the patient provides answers to each question. With the patient's consent, the entire session is recorded by at least one or more video-cameras placed in the room, with audio recording as well. This electronic health records system provides numerous advantages including, but not limited to:

1) Reduction in medical and legal liability.

2) Maintaining complete privacy between doctor and patient.

3) Optional web-based system.

4) Compatible with Internet Explorer and Webcam systems can be used.

5) One exemplary system used is VideoCapX by Fath System (www.fathsoft.com)

### Example 2

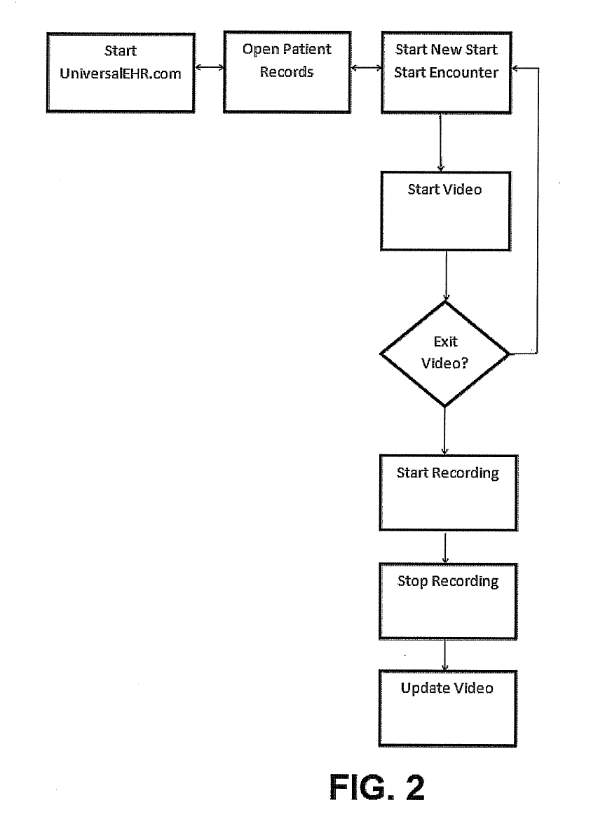

Referring to the flow-chart in FIG. 2, a method is provided for managing electronic health records is provided, comprising:

receiving, using an interface element in at least one specially programmed general-purpose computer, first data regarding at least one condition related to a patient, second data regarding at least one symptom of the patient related to physical or mental health of the patient, and background data for the patient; storing the first, second, and background data in a memory element for the at least one specially programmed general-purpose computer;

generating, using a processor in the at least one specially programmed general-purpose computer and the first, second, and background data, information regarding at least one concern applicable to the physical or mental health of the patient;

generating, using the processor and the first, second, and background data, at least one action item for addressing the at least one concern;

storing, in the memory element, the at least one action item;

transmitting, using the interface element, at least a portion of the information regarding the at least one concern for the physical or mental health of the patient for display and the at least one action item for display;

receiving, using the interface element, third data regarding compliance with the at least one action item, the third data including information as to whether the at least one action item has been complied with; and

when the at least one action item has not been complied with, transmitting, using the interface element, the at least one action item for display; or,

when the at least one action item has been complied with, modifying the stored at least one action item to indicate that the at least one action has been complied with; and

transmitting for display, using the interface element, a message that the at least one action item has been complied with, wherein the at least one condition is selected from the group consisting of information about past medical history and the medical history of the patient's relatives.

Other aspects of the invention include methods and systems wherein the computer operating system is capable of (1) analyzing the stored digitized data via an executable software application; (2) displaying the digitized data during electronic communication with a third party; (3) electronically transmitting the digitized data to a third party; (4) tagging said digitized data to facilitate searching and analysis thereof.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of producing and storing information related to medical health of at least one patient comprising:
1) capturing data gleaned by audio and video recording of an interview with said at least one patient conducted by a health-care professional,
2) electronically digitizing said data, and
3) storing said digitized data in an electronic format in a computer having an operating system capable of accessing, editing, analyzing, and searching said stored digitized data.

2. The method of claim 1 wherein said computer operating system is also capable of analyzing said stored digitized data via an executable software application.

3. The method of claim 1 wherein said computer operating system is also capable of displaying said digitized data during electronic communication with a third party.

4. The method of claim 1 wherein said computer operating system is also capable of electronically transmitting said digitized data to a third party.

5. The method of claim 1 wherein said computer operating system is capable of tagging said digitized data to facilitate searching and analysis thereof.

6. A system for producing and storing information related to medical health of at least one patient comprising:
1) audio and video recording elements capable of capturing data gleaned by audio and video recording of an interview with said at least one patient conducted by a health-care professional,
2) means for electronically digitizing said data, and
3) means for storing said digitized data in an electronic format in a computer having an operating system capable of accessing, editing, analyzing, and searching said stored digitized data.

7. The system of claim 6 wherein said computer operating system is also capable of analyzing said stored digitized data via an executable software application.

8. The system of claim 6 wherein said computer operating system is also capable of displaying said digitized data during electronic communication with a third party.

9. The system of claim 6 wherein said computer operating system is also capable of electronically transmitting said digitized data to a third party.

10. The system of claim 6 wherein said computer operating system is capable of tagging said digitized data to facilitate searching and analysis thereof.
